(19) United States
(12) Patent Application Publication
(10) Pub. No.: US 2010/0218413 A1
(43) Pub. Date: Sep. 2, 2010

(54) Replaceable tail for fishing lure

(76) Inventors: David L. Simmons, Sevierville, TN (US); Dewell Walker, Buras, LA (US)

Correspondence Address: KNOX PATENTS, P.O. BOX 30034, KNOXVILLE, TN, 37930-0034, US

(21) Appl. No.: 12/394,174

(22) Filed: Feb. 27, 2009

(51) Int. Cl. A01K 85/00; A01K 85/01

(52) U.S. Cl. 43/42.09; 43/42.06; 43/42.32; 43/42.31; 43/42.28

(57) ABSTRACT

Apparatus for a tail releasably attachable to a fishhook. A tail includes an attractor and a connector. The attractor has features that are attractive to fish, including an appearance of prey. The attractor, in one embodiment, includes a tubular member. The tubular member variously includes iridescent material and is configured to receive and hold captive accessories, such as rattles and scented pads. The attractor, in other embodiments, includes sheets, streamers, simulated worms, and/or other devices that are attractive to fish. The connector includes a plug that is attached to the attractor. The plug is a material that allows the point of a fishhook to penetrate the plug. The plug is sufficiently resilient that, after being penetrated by the point, the plug grips the fishhook shank with sufficient force that the plug is retained on the fishhook.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to fishing lures. More particularly, this invention pertains to fishing lures in which the tail is readily replaceable without tools.

2. Description of the Related Art

Fishing is both a sport and a livelihood for many. To catch fish with a hook, the fish must be enticed to strike the hook such that the barb of the hook impales the flesh of the fish. To entice fish, hooks often hold bait or are integrated or attached to a lure, which is an object that resembles fish prey.

Known fishing lures have a variety of shapes and configurations. In general, these shapes and configurations are intended to attract and entice fish to strike the lure. In many cases, lures are designed to imitate the prey of the fish attempted to be caught. Such prey includes a vulnerable fish, a worm, or an insect

Generally, lures attract fish by the appearance of the lure and/or the movement of the lure through or on the water. With respect to appearance, the shape, configuration, color, and reflectance, among other attributes may attract a specific species of fish. With respect to movement, some lures float like a bug on the surface of the water, other lures move vertically like prey, and still others wiggle in the water as they move horizontally, which mimics the movement of a fish.

Often, fishing is a time consuming sport. The equipment, including lures, are used for extended periods of time. As such, the equipment wears out and needs to be replaced. In particular, lures often include delicate members that break or are damaged during extensive use.

### BRIEF SUMMARY OF THE INVENTION

According to various embodiments of the invention, a replaceable tail for a fishing lure is provided. A tail for a fishing lure includes an attractor and a connector. The connector receives the hook of the lure and is configured to removably secure the tail to the shank of the hook. In this way, the tail of a fishing lure is replaceable when it wears out or is not appropriate for the current fishing conditions.

In one embodiment, the tail includes an attractor with a mesh or cylindrical braid, such as a biaxial braid, construction. In various such embodiments, the tubular member is sized to receive an accessory, such as a rattler and/or a scent carrying device, and the tubular member includes a retainer, such as a stopper or a clip, that prevents the accessory from escaping the confines of the tubular member. In another embodiment, the attractor includes one or more sheets of material. In yet other embodiments, the attractor includes a device having a configuration suitable for using with a fishhook.

The connector includes a plug that is attached to the attractor. The plug is a rubber-like material that is readily penetrated by a fish hook and is sufficiently resilient to grip the shank of the hook when inserted into the plug. The plug is secured to the attractor by a member clamping the plug and attractor together, for example, by a section of heat shrink tubing, an adhesive, or by wrapping a line around the attractor and plug.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a side view of one embodiment of a fishing lure having one embodiment of a tail;

FIG. 2 is an exploded view of another embodiment of a tail;

FIG. 3 is an oblique view of one embodiment of a tubular member;

FIG. 4A is an exploded view of one embodiment of a tail;

FIG. 4B is an exploded view of another embodiment of a tail;

FIG. 5 is an end view of the embodiment of the tail shown in FIG. 4A;

FIG. 6 is a view of another embodiment of a fishing lure having another embodiment of a tail;

FIG. 7 is an exploded view of the embodiment of the tail shown in FIG. 6; and

FIG. 8 is an end view of the embodiment of the tail shown in FIG. 6.

### DETAILED DESCRIPTION OF THE INVENTION

Apparatus for a replaceable tail 100 for a fishing lure is disclosed. The tail is configured to be removable and replaceable on a hook 106.

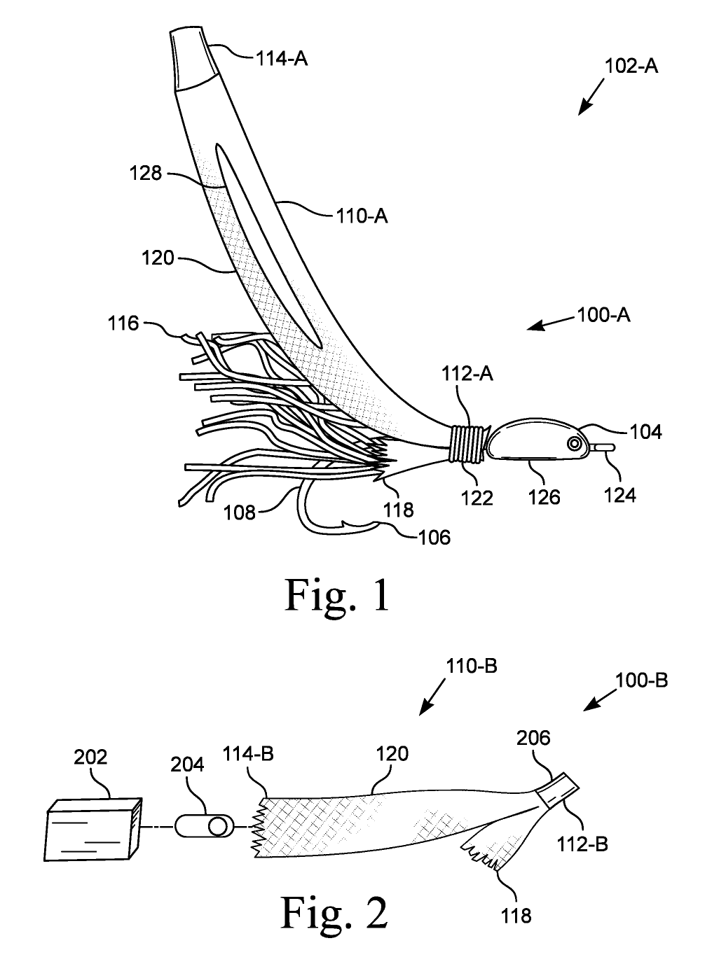

FIG. 1 illustrates a side view of one embodiment of a fishing lure 102-A having one embodiment of a tail 100-A. The tail 100-A is configured to attach to a fish hook 106 to aid in attracting fish for capture. The tail 100-A is configured to be attached extending away from a lead line attached to an eyelet 124 opposite the point of the fish hook 106. In the illustrated embodiment, the lure 102 includes a jig 104 having a glass bead body 126 and an imbedded hook 106, with the tail 100-A attached to the shank 108 of the hook 106.

The tail 100-A includes an attractor 110-A and a connector 112-A. Typically, the attractor 110 attracts fish by its shape, color, movement through the water, or some other characteristic that is deemed desirable. The connector 112-A connects, or attaches, the tail 100 to the hook 106 of the lure 102. The shank 108 of the hook 106 passes through the connector 112-A, which grips the shank 108.

In the illustrated embodiment, the attractor 110-A includes a tubular member 120 that extends from the connector 112-A. One end 114-A of the tubular member 120 is semi-closed and sealed so as to prevent fraying of the tubular member 120. Along at least one side of the tubular member 120 is a stripe or other coloration 128. The opposite end 118 of the tubular member 120 is frayed. Extending from the opposite end 118 is a group of streamers or filaments 116. The streamers 116 are ribbons of material that are flexible. The general configuration of the tubular member 120, the stripe 128, the opposite end 118, and the streamers 116 are features of the attractor 110-A intended to be attractive to fish and to cause a fish to strike at the lure 102-A. In various configurations, the attractor 110 represents fish prey.

The illustrated connector 112-A includes a string 122 that is wrapped around a portion of the tubular member 120. The string 122 secures a medial portion of the tubular member 120 to the connector 112-A.

FIG. 2 illustrates an exploded view of another embodiment of a tail 100-B. The illustrated tail 100-B has an attractor 110-B that includes a tubular member 120 configured to contain one or more accessories that aid in the capture of fish. The tubular member 120 is hollow or has a cavity that is dimensioned to receive one or more accessories 202, 204, for example, a rattle 204. The rattle 204 fits inside the end 114-B of the tubular member 120, along with a pad 202 that secures the rattle 204 in the tubular member 120. The pad 302 is sized and shaped to fit into the end 114-B of the tubular member 120 and wedge into place, thereby preventing the rattle 204 from falling out of the end 114-B. The rattle 204 is contained in a cavity between the end 114-B and the connector 112-B. The connector 112-B pinches a portion of the tubular member 120 such that the rattle 204 is held captive and cannot pass through the tubular member 120.

In another embodiment, the end 114-B of the tubular member 120 is as illustrated in FIG. 1, which shows the end 114-B being semi-closed. In such an embodiment, the pad 202 is not needed to keep the rattle 204 inside the tubular member 120. In yet other embodiments, the end 114-B of the tubular member 120 is closed or made smaller than the accessories 204, 204 contained in the tubular member 120, thereby keeping the accessories 202, 204 inside the tubular member 120. For example, the end 114-B is tied with a string, closed with a rubber band, or the tubular member 120 is tied into a knot.

In yet another embodiment, bait is positioned inside the end 114-B of the tubular member 120. For example, live bait such as a shrimp or a small fish is partially inserted into the tubular member 120 and the tendency of the tubular member 120 to constrict when tugged serves to capture the bait in the tubular member 120. The tubular member 120 acts similarly to a children's finger trap in which a tube constricts upon the fingers inserted in the tube when the fingers are pulled apart. The bait is inserted in the end 114-B of the tubular member 120 and the movement of the live bait as it tries to escape causes the bait to be captured tightly in the tubular member 120. In other examples, cut bait is inserted in the end 114-B of the tubular member 120 and the tubular member 120 is pulled to constrict the end 114-B around the cut bait.

In one embodiment, the pad 202 is an absorbent material, for example, a sponge or an open cell foam material, that receives a smelling agent or otherwise releases a scent. The smelling agent adds to the attractiveness of the attractor 110-A. In other embodiments, the pad 202 is a material with neutral or positive buoyancy, such as a closed cell foam. In one such embodiment, the pad 202 is a capsule that contains air, which provides buoyancy. The capsule 202 is transparent or translucent such that the iridescence of the tubular member 120 is not obstructed by the capsule 202.

The illustrated connector 112-B includes a flat wrap or film 206, such as tape or a cured film, that is wrapped around or surrounds a medial portion of the tubular member 120 to secure the tubular member 120 to the connector 112-B. In another embodiment, connector 112-B includes string 122 that is used to secure the tubular member 120.

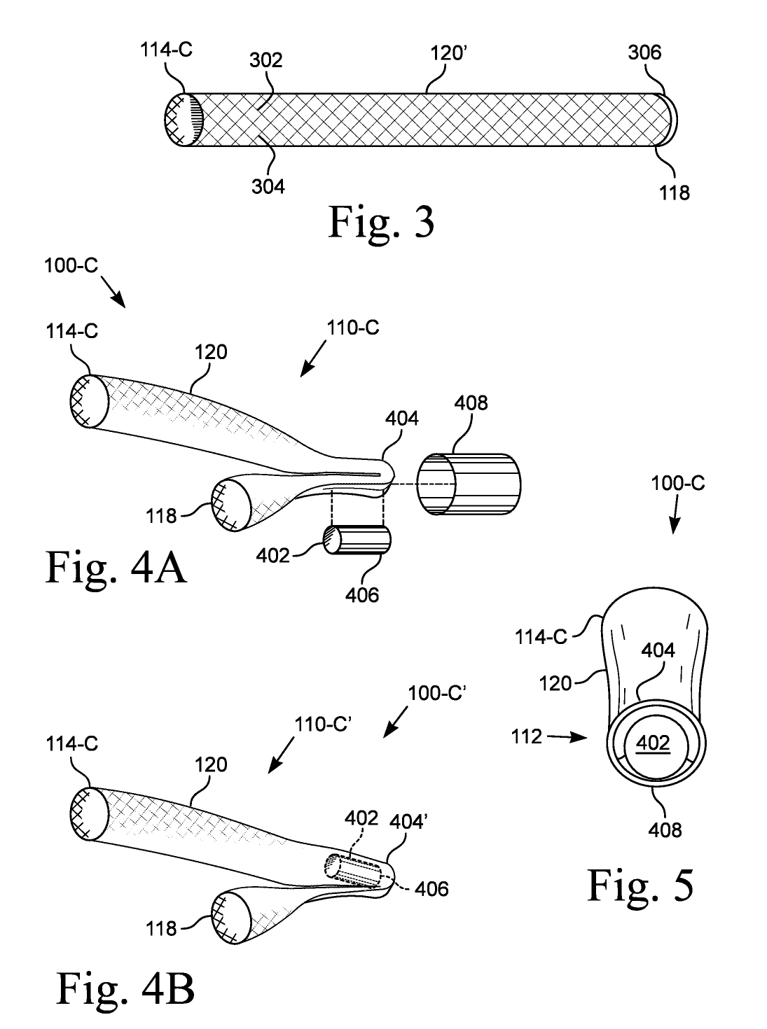

FIG. 3 illustrates an oblique view of one embodiment of a tubular member 120′. The tubular member 120′ is a hollow cylinder having a mesh or cylindrical braid construction. The tubular member 120′ is flexible and resilient, and it can be folded, tied into a knot, or otherwise manipulated to have a desired configuration. The tubular member 120′ includes a warp 302 and a weft 304 that is loosely braided. The illustrated embodiment has an end 114-C that is square cut, as is the opposite end 118. In various embodiments, the ends 114, 118 of the tubular member 120′ are frayed by separating the warp 302 from the weft 304, thereby forming streamers or filaments that extend from the main body of the tubular member 120′. By fraying the ends 114, 118 of the tubular member 120′, the attractor 100 is made more attractive to certain types of fish and is also suited for certain types of fishing conditions. In other embodiments, the ends 114, 118 are sealed or otherwise treated to prevent fraying and/or to hold captive any accessories in the tubular member 120′.

The diameter of the tubular member 120′ changes based on the tension applied to the member 120′. For example, pulling the tubular member 120 along the longitudinal axis causes the tubular member 120′ to lengthen and have a smaller diameter. Likewise, pushing the two ends 114, 118 together causes the diameter of the tubular member 120′ to increase. This feature is useful when accessories, such as the pad 202 and/or the rattle 204, are inserted into the tubular member 120′ because the diameter is variable to accommodate and secure any accessories contained inside the tubular member 120′.

In one embodiment, the tubular member 120′ includes an iridescent material. For example, the weft 304 is a narrow ribbon that has iridescent properties. One such tubular member 120′ is decorative designer ribbon that is made of acrylic. Iridescent film is a transparent or translucent optical effect film in which the perceived color changes depending on the viewing angle. When submersed in water, the tubular member 120′ with the iridescent material has a multicolored presentation and also reflects light.

In the illustrated embodiment, a sealed edge 306 is shown at one end 118. When working with the tubular member 120, the warp 302 and the weft 304 fray and become separated at the ends 114-C, 118, as illustrated in FIG. 2. To prevent unnecessary and/or undesirable fraying, a sealant is applied to the end 118 to form a sealed edge 306. One method of forming the sealed edge 306 is to dip the end of a freshly cut tubular member 120 into a liquid material, such as Plasti Dip, and allow the material to cure. When the end 118 of the tubular member 120 is desired to be worked or have a special treatment, the sealed edge 306 is cut off.

FIG. 4A illustrates an exploded view of one embodiment of a tail 100-C. FIG. 5 illustrates an end view of the embodiment of the tail 100-C shown in FIG. 4A. The tubular member 120 that is the attractor 110-C is folded at a medial point 404 such that the portion of the tubular member 120 that terminates at one end 114-C is longer than the portion of the tubular member 120 that terminates at the other end 118. A plug 402 is positioned proximate the tubular member 120 with an end 406 of the plug 402 adjacent to the medial point 404 of the tubular member 120. The width of the tubular member 120 at the flattened medial point 404 is such that the tubular member 120 wraps around a portion of the circumference of the plug 402. In another embodiment, one end 118 of the tubular member 120 is attached to the plug 402 with the remainder of the tubular member 120 extending away from the plug 402, that is, the tubular member 120 is not folded at a medial point 404 and the plug 402 is positioned adjacent the end 118 of the tubular member 120.

In various embodiments a member is wrapped or positioned around the attractor 110 and the plug 402 to form a unitary tail 100 in which the attractor 110 and the plug 402 are clamped together. The tubular member 120 is attached to the plug 402 to form a connector 112. FIG. 4A shows a piece of heat shrink tubing 408 that is sized to fit over the folded end 404 of the tubular member 120 and the plug 402. After heat is applied to the heat shrink tubing 408, the tubing 408 shrinks to fit around and clamp the medial portion 404 and the plug 402 together, as illustrated in FIG. 5, to form a connector 112. In one such embodiment, the medial portion 404, the plug 402, and the heat shrink tubing 408 after shrinking are coated with a film 206 to form a connector 112-B as illustrated in FIG. 2. For example, a coating is applied over the medial point 404, the plug 402, and the heat shrink tubing 408. After the coating cures, the tubular member 120 is secured to the plug 402 to form a connector 112-B such as illustrated in FIG. 2. The coating forms a thin, flexible, and resilient film around the member 120 and the plug 402. One such coating material is known as Plasti Dip.

In another example, a string 122 is wrapped around the tubular member 120, thereby securing the tubular member 120 to the plug 402. FIG. 1 illustrates such an embodiment. In another example, a film or tape 206 around the tubular member 120 secures the tubular member 120 to the plug 402. In still other examples, the tubular member 120 is secured to the plug 402 with tape, rubber bands, adhesive, or other material that securely attaches the folded tubular member 120 to the plug 402. The connector 112 in such embodiments may also be coated as described above.

The plug 402 is elongated with a longitudinal axis. The illustrated embodiment shows a cylindrical plug 402, although other shapes are possible. The plug 402 is made of a resilient material. The material used for the plug 402 is suitable to be penetrated by a fishhook 106 with the shank 108 being substantially parallel to the longitudinal axis of the plug 402. The material used for the plug 402 is resilient enough to grip the shank 108 of the hook 106 when the connector 112 is positioned on the shank 108. That is, the plug 402 is sufficiently resilient to support the tail 100 on the hook 106. The connector 112, with the plug 402, allows the tail 100 to be readily installed on a hook 106 without requiring tools or special skill, such as required when tying an attractor 110 directly to a jig 104. In one configuration, the plug 20 has a durometer of approximately 20.

If the hook 106 is barbed, when the hook 106 is removed from the plug 402 with care, the tail 100 may be reusable. If care is not exercised when removing the tail 100 from the barbed hook 106, then the plug 402 is susceptible to damage and the plug 402, when reused, may not grip the shank 108 with sufficient force to remain stationary on the hook 106 when the lure 102 is in use. Some jigs 104 include a barb that protrudes from the shank 108. With such jigs 104, the plug 402 is securely fixed to the jig 104 and is potentially difficult to remove, particularly without damaging the plug 402.

The plug 402 is sized based on the dimensions of the hook 106 and shank 108, with larger diameter plugs 402 being used with larger hooks 106. The length of the plug 402 is such that the plug 402 grips the shank 108 with sufficient force that the tail 100 does not readily rotate about the shank 108 and the plug 402 does not readily slide along the shank 108 when the lure 102 is being used. In various configurations, the plug 402 is a solid cylinder or a hollow cylinder with a through-opening that has a diameter less than the diameter of the shank 108.

FIG. 4B illustrates an exploded view of another embodiment of a tail 100-C′. In the illustrated embodiment, the plug 402 is positioned inside the tubular member 120 proximate the medial point 404′, where the tubular member 120 is folded to form two sections that extend away from the medial point 404′. The end 406 of the plug 402 is positioned proximate the medial point 404′. The plug 402 is captive in the tubular member 120, which is the attractor 110-C′. The connection 112 is formed by variously fixing the tubular member 120, or the attractor 110-C′, to the plug 402, such as described above.

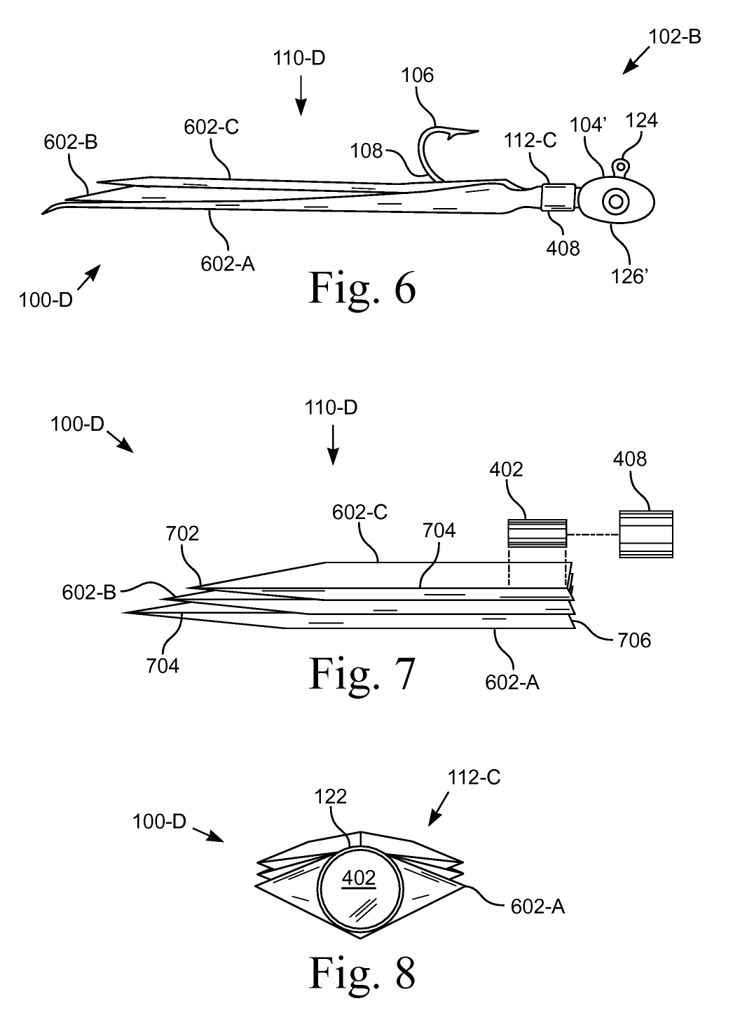

FIG. 6 illustrates a view of another embodiment of a fishing lure 102-B having another embodiment of a replaceable tail 100-D. FIG. 7 illustrates an exploded view of the embodiment of the tail 100-D shown in FIG. 6. FIG. 8 illustrates an end view of the embodiment of the tail 100-D shown in FIG. 6. Applicants hereby incorporate by reference U.S. application Ser. No. 11/846,599, filed Aug. 29, 2007.

The illustrated lure 102-B includes a jig 104′ that has a head 126′ with a eyelet 124 and a hook 106. The head 126′ of the jig 104′ is a lead sinker with the hook 104 molded into the head 104′. A portion of the shank 108 of the hook 106 is surrounded by the head 126′ of the jig 104′. The eyelet 124 provides an attachment point for connecting a fish line to the lure 102-B. In the illustrated embodiment, the jig 104′ resembles the head of a small fish.

The tail 100-D includes an attractor 110-D and a connector 112-C. The attractor 110-D includes multiple layers 602-A, 602-B, 602-C of sheets of material that have a longitudinal fold 704. The layers 602-A, 602-B, 602-C are oblong, with the outboard end 702 having a point and the inboard end 706, which attaches to the plug 402. The layers 602-A, 602-B, 602-C have a V-shape with the fold 704 forming the apex of the V-shape. In the assembled configuration of the lure 102-B illustrated in FIG. 6, the outboard end 702 of the layers 602-A, 602-B, 602-C are separated to form a full shape.

The layers 602-A, 602-B, 602-C have a progressively shorter length from the outermost layer 602-A to the innermost layer 602-C. The lure 102-B is assembled by stacking the layers 602-A, 602-B, 602-C and placing the plug 402 adjacent the fold 704 in the innermost layer 602-C. A section of heat shrink tubing 408 is positioned around the layers 602-A, 602-B, 602-C and the plug 402 and then shrunk to secure the layers 602-A, 602-B, 602-C to the plug 402. The hook 106 is then inserted along the longitudinal axis of the plug 402 to attach the tail 100-D to the hook 106. In another embodiment, the middle layer 602-B does not have a center fold 704 or the center fold 704 extends only a short distance from the inboard end 706. In such an embodiment, the outer layer 602-A is forced apart or away from the inner layer 602-C proximate the outboard end 702.

The illustrated embodiment shows the plug 402 attached to the layers 602-A, 602-B, 602-C with a section of heat shrink tubing 408 to form a connector 112-C. In other embodiments, the attractor 110-D is attached to the plug 402 by some other method such that the plug 402 is secured to the attractor 110-D.

In various embodiments, the attractor 110-D includes one or more iridescent members 602-A, 602-B, 602-C. For example, the outermost layer 602-A of the attractor 110-D is an iridescent film, or sheet. In one embodiment, the innermost layer 602-C is also an iridescent film, or sheet and each of the middle layers 602-B is a transparent or translucent colored film, or sheet. In various embodiments, each layer 602-A, 602-B, 602-C is formed of one or more individual sheets. The layers 602-A, 602-B, 602-C are sufficiently rigid to hold the fold 704 formed in the layers 602-A, 602-B, 602-C.

In various embodiments, the layers 602-A, 602-B, 602-C have a thickness ranging from approximately 1 to 5 mils, with the layers 602-A, 602-B, 602-C having a stiffness sufficient for the attractor 110-D to maintain its shape and configuration when attached to the jig 104′ as illustrated in FIG. 6.

Iridescent film is a transparent or translucent optical effect film in which the perceived color changes depending on the viewing angle. One type of iridescent film includes multiple, ultra-thin polymer layers that alter the path of visible light so that specific wavelengths are reflected while permitting the remainder of the light to be transmitted through the layers. By positioning a colored sheet 602-B adjacent an iridescent sheet 602-A, 602-C, the attractor 110-D, when submersed in water, has a multicolored presentation dominated by the color of the colored sheet 602-B. In other embodiments, the middle layer 602-B is omitted or is another sheet of iridescent film. In such embodiments, the attractor 110-D is more translucent as the attractor 110-D presents a multitude of colors.

In various embodiments, one or more of the sheets 602-A, 602-B, 602-C is crumpled, that is, the sheet 602-A, 602-B, 602-C is crushed such as to form irregular folds and/or wrinkles, and then returned to its elongated, folded shape. In another embodiment, the sheet 602-A, 602-B, 602-C is textured so as to present a surface that is not flat, but is covered with raised features. The irregular folds and wrinkles result in the sheet 602-A, 602-B, 602-C having a multitude of almost parallel sections of sheet, with each section having a different color because the sheet sections are not exactly parallel. In such an embodiment, the attractor 110-D presents a multitude of colors, simultaneously. In another such embodiment, the middle sheet 602-B is a thin sheet that is crumpled and then straightened. The middle sheet 602-B is positioned between two translucent sheets 602-A, 602-C that support the thinner middle sheet 602-B.

In yet other embodiments, the attractor 110-D includes other features that are attractive to fish. Such features include worms, streamers, filaments, fins, and other devices.

The replaceable tail 100 includes various functions. The function of attaching the tail 100 to a hook 106 is implemented, in one embodiment, by the plug 402, which is attached to an attractor 110. The plug 402 is a material that is configured to be penetrated by the hook 106 and is resilient enough to grip the shank 108 of the hook 106.

The function of securing accessories within the attractor 110 is implemented, in one embodiment, by the attractor 110 including a tubular member 120 receiving one or more accessories 202, 204 and holding those accessories 202, 204 captive within the tubular member 120. In one such embodiment, the accessory 202 includes a pad 202 that is dimensioned to be held captive within the opening at the end 114-B of the tubular member 120. In other embodiments, the end 114-B of the tubular member 120 is closed sufficiently to hold the accessories 202, 204 captive, for example, by using a rubber band or other device to restrict the opening, tying the member 120 into a knot, or applying a coating that fixes the end 114-B with a reduced size.

The function of attracting fish is implemented, in one embodiment, by the attractor 110 including an iridescent material. In various embodiments, the attractor 110 includes iridescent material incorporated in the tubular member 120 and/or sheets 602.

From the foregoing description, it will be recognized by those skilled in the art that a replaceable tail 100 has been provided. The tail 100 includes an attractor 110 and a connector 112. The attractor 110 attracts fish, by resembling prey or some other object that will cause a fish to strike the lure 102.

The attractor 110 is a device that is used in conjunction with a hook 106 for fishing. In various embodiments, the attractor 110 includes a tubular member 120 that variously includes one or more features deemed attractive to fish. Examples of such features includes stripes 128, streamers 116, strips, simulated worms, scented pads 202, rattles 204, and/or iridescent material 302, 304, among others. Other embodiments have attractors 110-D that include sheets 602 and also variously include features deemed attractive to fish.

The connector 112 includes a plug 402 secured to the attractor. The plug 402 is configured to support the attractor 110 on the hook 106 of a lure 102 with a desired orientation and position. The plug 402 is easily penetrated by the point of the hook 106. The plug 402 is resilient such that the plug 402 grips the shank 108 of the hook 106 after the hook 106 penetrates the plug 402.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus providing a removable tail for a fishing lure, said apparatus comprising:
a fishhook having a point and a shank;
an attractor configured for fishing, said attractor including a tubular member with a braided construction, said tubular member being flexible and resilient, said tubular member defining a cavity dimensioned to receive an accessory; and
a plug secured to said attractor, said plug being elongated with a longitudinal axis, said plug receiving said point of said fishhook, said plug slideably engaging said fishhook such that said plug is removable from said fishhook, and said plug being resilient such that said plug grips said shank of said fishhook with sufficient force to support said attractor on said fishhook.

2. The apparatus of claim 1 wherein said attractor is secured to said plug by a member positioned around said attractor and said plug, and said member clamping said plug and said attractor together.

3. The apparatus of claim 1 wherein said tubular member includes an iridescent material.

4. The apparatus of claim 1 wherein said attractor includes a rattle.

5. The apparatus of claim 1 wherein said attractor includes a pad configured to receive a smelling agent and said tubular member has a closure that retains said pad inside said tubular member.

6. An apparatus providing a tail for a fishing lure, said apparatus comprising:
an attractor configured for fishing; and
a plug secured to said attractor, said plug being elongated with a longitudinal axis, said plug configured to receive a point of a fishhook, said plug configured to engage a shank of the fishhook with the shank substantially aligned with said longitudinal axis of said plug, said plug being resilient such that said plug is capable of gripping the shank of the fishhook with sufficient force to support said attractor on the fishhook after said plug receives said point, and said plug configured to slideably engage the fishhook such that said plug is removable from the fishhook.

7. The apparatus of claim 6 wherein said plug is secured to said attractor by a tube positioned around said attractor and said plug, and said tube clamping said plug and said attractor together.

8. The apparatus of claim 6 wherein said attractor includes a tubular member that defines a cavity dimensioned to receive an accessory.

9. The apparatus of claim 8 wherein said accessory is a rattle and said tubular member has a closure that retains said rattle inside said cavity.

10. The apparatus of claim 8 wherein said accessory is a pad configured to receive a smelling agent and said tubular member has a closure that retains said pad inside said cavity.

11. The apparatus of claim 6 wherein said attractor includes a tubular member with a braided construction, said tubular member being flexible and resilient.

12. The apparatus of claim 6 wherein said attractor includes at least one sheet extending away from said plug.

13. The apparatus of claim 6 wherein said attractor includes a material that is iridescent.

14. An apparatus providing a tail for a fishing lure, said apparatus comprising:
an attractor including a tubular member, said attractor configured for fishing; and
a connector attached to said attractor, said connector including a material penetrable by a point of a fishhook, said material being resilient such that said material is capable of supporting said attractor relative to said fishhook when said fishhook has penetrated said material.

15. The apparatus of claim 14 wherein said material is sufficiently resilient to be removable from the fishhook when said fishhook has penetrated said material.

16. The apparatus of claim 14 wherein said attractor is attached to said connector by a member positioned around said attractor and said plug.

17. The apparatus of claim 14 wherein said tubular member defines a cavity dimensioned to receive an accessory.

18. The apparatus of claim 17 wherein said accessory is a rattle and said tubular member has a closure that retains said rattle inside said cavity.

19. The apparatus of claim 17 wherein said accessory is a pad configured to receive a smelling agent and said tubular member has a closure that retains said pad inside said cavity.

20. The apparatus of claim 14 wherein said tubular member includes an iridescent material.
